(19) United States
(12) Patent Application Publication
(10) Pub. No.: US 2014/0200761 A1
(43) Pub. Date: Jul. 17, 2014

(54) BRAKE CHAMBER WITH SENSOR

(71) Applicant: BENDIX COMMERCIAL VEHICLE SYSTEMS LLC, Elyria, OH (US)

(72) Inventor: Majed M. Hamdan, North Olmsted, OH (US)

(73) Assignee: BENDIX COMMERCIAL VEHICLE SYSTEMS LLC, Elyria, OH (US)

(21) Appl. No.: 13/742,817

(22) Filed: Jan. 16, 2013

(51) Int. Cl. B60T 17/22

(52) U.S. Cl. CPC B60T 17/221
USPC 701/34.4

(57) ABSTRACT

A brake chamber includes a housing defining a service air brake volume. A diaphragm is associated with a plate that is movably secured within the housing. The diaphragm divides the service air brake volume into a pressure portion and a non.-pressure portion. Respective volumes of the pressure portion and the non-pressure portion change as the diaphragm moves within the housing. A sensor is in the service air brake volume. Electronics, associated with the sensor, determine a position of the plate in the housing.

### BACKGROUND

The present invention relates to a brake monitor. It finds particular application in conjunction with monitoring service brakes on heavy vehicles and will be described with particular reference thereto. It will be appreciated, however, that the invention is also amenable to other applications.

Heavy-duty trucks, buses, and other large vehicles are typically equipped with a pneumatic brake actuating system. When a service brake pedal is depressed by an operator of the vehicle, the brake actuating system typically applies air under pressure to a plurality of service chambers, which cause respective push rods and diaphragms to move. Each of the push rods is connected to a respective linkage for actuating an associated service brake on the vehicle. Each push rod has a predetermined range of available movement (e,g., stroke).

Excessive movement or stroke of the push rod may be created by various factors. Typically, such excessive movement is due to brake lining wear. For example, as the brakes wear, more movement of the push rod is required to actuate the brakes. Further, over time the linkages and connections between the push rod and the linkages may bend, become loose, or excessively worn, which may require additional push rod stroke to actuate the brakes. One or more of these factors may cause the amount of push rod movement required to actuate the brakes to approach the maximum push rod stroke available from the brake actuator.

In other situations, a service brake may remain stuck in the applied or partially applied position even after the service brake pedal is released. With a service brake stuck in the applied position, the associated push rod likely will not return to its anactuated position.

For the reasons discussed above, it may be desirable to monitor the movements and positions of the respective push rods, either directly or indirectly.

The present invention provides a new and improved apparatus and method which addresses the above-referenced problems.

### SUMMARY

In one embodiment, a brake chamber includes a housing defining, a service air brake volume. A diaphragm is associated with a plate that is movably secured within the housing. The diaphragm divides the service air brake volume into a pressure portion and a non-pressure portion. Respective volumes of the pressure portion and the non-pressure portion change as the diaphragm moves within the housing. A sensor is in the service air brake volume. Electronics, associated with the sensor, determine a position of the plate in the housing.

### BRIEF DESCRIPTION OF THE :DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a brake system in accordance with one embodiment of an apparatus illustrating principles of the present invention;

FIG. 2 illustrates a schematic representation of a brake actuator in a Brake Off position in accordance with one embodiment of an apparatus illustrating principles of the present invention;

FIG. 3 illustrates a schematic representation of the brake actuator in a Brake On position in accordance with one embodiment of an apparatus illustrating principles of the present invention;

FIG. 4 illustrates a schematic representation of a field of view of a pattern in the Brake Off position in accordance with one embodiment of an apparatus illustrating principles of the present invention;

FIG. 5 illustrates a schematic representation of a field of view of a pattern in the Brake On position in accordance with one embodiment of an apparatus illustrating principles of the present invention; and

FIG. 6 is an exemplary methodology of determining a position of a diaphragm in a service brake volume in accordance with one embodiment illustrating principles of the present invention.

### DETAILED DESCRIPTION OF ILLUSTRATED EMBODIMENT

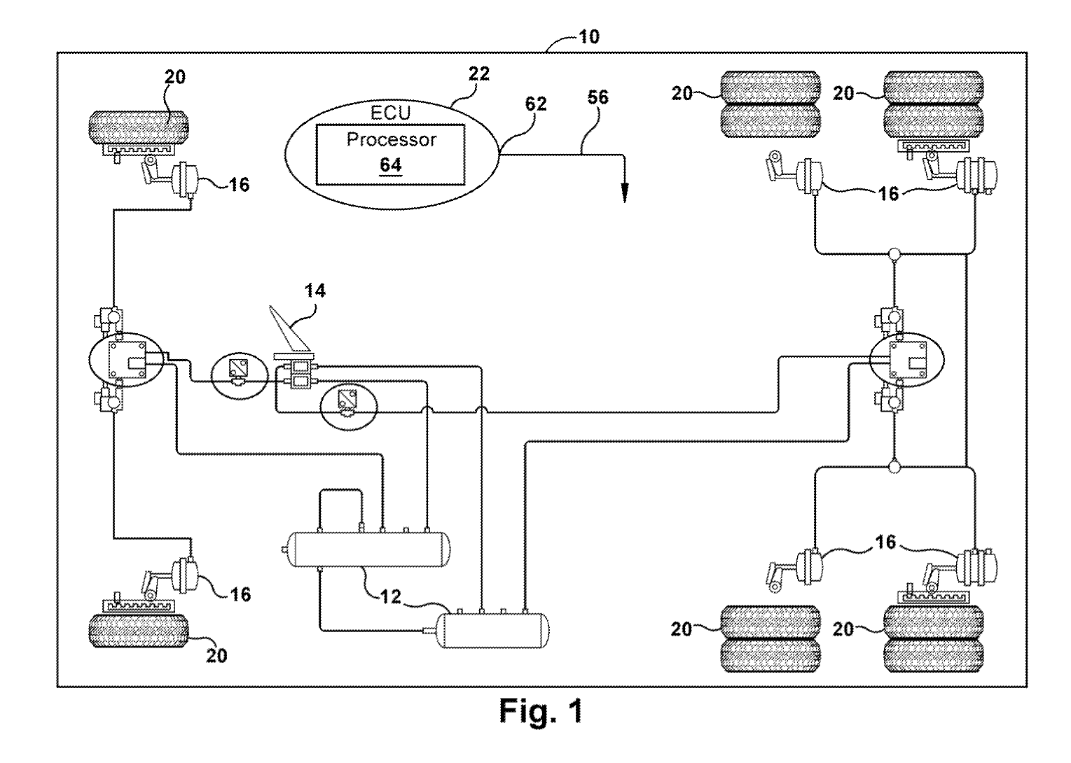

With reference to FIG. 1, a simplified component diagram of a vehicle 10 including a braking system is illustrated in accordance with one embodiment of the present invention. The braking system includes reservoirs 12 for storing compressed fluid (e.g., air) used for braking the vehicle 10. A service brake pedal 14 is operated by an operator of the vehicle 10 for controlling the application of service brakes on the vehicle. More specifically, when the service brake pedal 14 is depressed by the operator, the compressed air is transmitted from at least one of the reservoirs 12 to brake actuators 16, which are associated with respective wheels 20 of the vehicle 10, for causing the service brakes to be applied. When the service brake pedal 14 is released (e.g., no longer depressed by the operator), the compressed air is exhausted from the brake actuators 16 for causing the service brakes to be released (e.g., no longer applied).

An electronic control unit (ECU) 22 electronically controls the brake actuators 16 via electro-pneumatic devices, such as modulators and traction relay valves, for applying and releasing, the service brakes under different conditions. For example, the ECU 22 may control one or more of the brake actuators 16 to cause respective ones of the service brakes to alternately be applied and released during an anti-lock braking event. In another example, the ECU 22 may control one or more of the brake actuators 16 to cause respective ones of the service brakes to be applied for reducing the chance of a roll event.

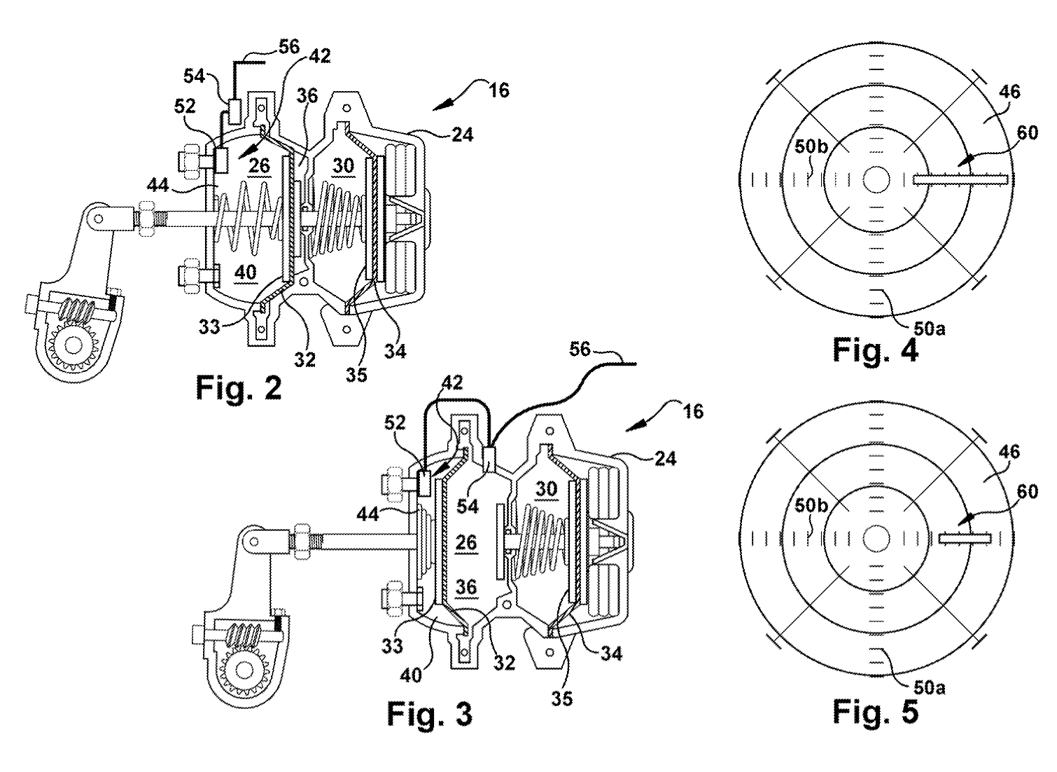

With reference to FIGS. 2 and 3, an exemplary brake actuator 16 is illustrated in a “Brake Off” condition (FIG. 2) and a “Brake On” condition (FIG. 3) in accordance with one embodiment of the present invention. The Brake Off condition refers to a condition when the service brakes of the vehicle 10 are not applied, and the Brake On condition refers to a condition when the service brakes of the vehicle 10 are partially or fully applied.

The brake actuator 16 includes a brake chamber housing 24, which defines a service brake volume 26 (e.g., a service brake chamber) and a parking brake volume 30 (e.g., a parking brake chamber). A service volume diaphragm 32 is associated with a plate 33 that is movably secured within the service brake volume 26. A parking volume diaphragm 34 is associated with a plate 35 that is movably secured within the parking brake volume 30. The service volume diaphragm 32 is associated and moves with the plate 33. The parking volume diaphragm 34 is associated and moves with the plate 35. In FIG. 2, both the service volume diaphragm 32 and the parking volume diaphragm 34 are illustrated in the Brake Off position. As discussed above, the service volume diaphragm 32 is illustrated in the position when the vehicle service brakes are not applied. Furthermore, the parking volume diaphragm 34 is illustrated in the position when the vehicle parking brakes (e.g., spring brakes) are not engaged,

The service brake volume 26 is sealingly divided by the service volume diaphragm 32 into two (2) sides (e.g., portions) a pressure side 36 (e.g., a pressure portion) and a non-pressure side 40 (e.g., a non-pressure portion). The non-pressure side 40 of the service brake volume 26 is maintained at atmospheric pressure. The pressure side 36 of the service brake volume 26 receives the pressurized fluid from at least one of the reservoirs 12 (see FIG. 1) When the service brake pedal 14 (see FIG. 1) is depressed. As pressure increases on the pressure side 36 of the service brake volume 26, the service volume diaphragm 32 moves into the non-pressure side $0 of the service brake volume 26. Consequently, the volume of the pressure side 36 of the service brake volume 26 becomes larger, and the volume, of the non-pressure side 40 of the service brake volume 26 becomes smaller as pressure is exhausted from the pressure side 36 of the service brake volume 26, the service volume diaphragm 32 moves back into the pressure side 36 of the service brake volume 26. Consequently, the volume of the pressure side 36 of the service brake volume 26 becomes smaller, and the volume of the non-pressure side 40 of the service brake volume 26 becomes larger.

A sensor 42 (e.g., an optical sensor) is included within the brake chamber housing 24. In one embodiment, the sensor 42 is included in the service brake volume 26. In the illustrated embodiment, the sensor 42 is included on the non-pressure side 40 of the service brake volume 26. For example, the sensor 42 is positioned proximate to a wall 44 of the brake chamber housing 24 across from the service volume diaphragm 32. It is contemplated that the sensor 42 is immovably secured proximate to a wall 44 of the brake chamber housing 24. However, it is to be understood that the sensor 42 may be easily accessible for servicing and/or replacement.

With reference to FIGS. 2-5, a pattern 46 is positioned M the housing 24 within a sensing range of the sensor 42. As illustrated, the pattern 46 includes a plurality of marks 50. In one embodiment, the marks 50 are lines. One group of the marks 50a extend horizontally along a substantially vertical line so that the marks 50a are substantially parallel to the other horizontal marks 50a. Another group of the marks 50b extend vertically along a substantially horizontal line so that the marks 50b are substantially parallel to the other vertical marks 50b.

The sensor 42 includes electronics 52, which electrically communicate with a connector 54. The connector 54 electrically communicates with as vehicle communication bus 56, which electrically communicates with the ECU 22. The sensor 42 is capable of transmitting signals (e.g., message signals) to the ECU 22 via the vehicle communication bus 56. In one embodiment, the electronics 52 associated with the sensor 42 determine if the service volume diaphragm 32 (and the plate 33) is in the Brake On or the Brake Off position. The message transmitted by the sensor 42 to the ECU 22 identifies the Brake On or Brake Off information. It is also contemplated that the sensor 42 is capable of receiving signals. (e.g., message signals) from the ECU 22 via the vehicle communication bus 56. Alternatively, the sensor may be connected directly to the ECU 22,

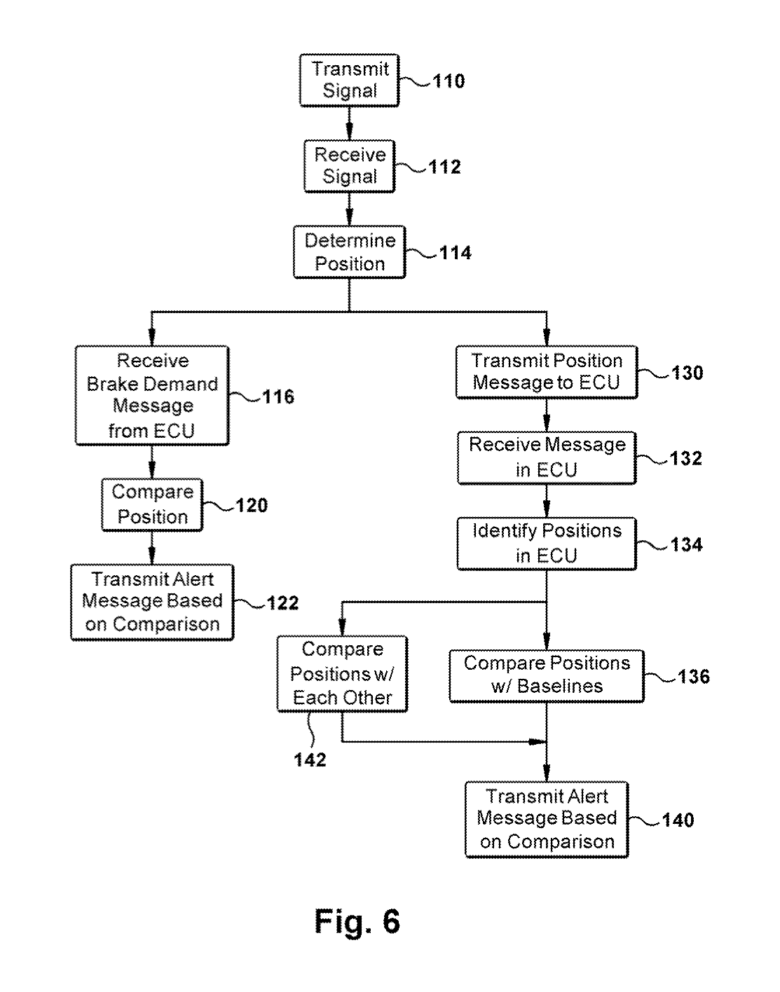

FIG. 6 is an exemplary methodology of the system shown in FIGS. 1-5. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-orienated or artificial intelligence techniques. It will further be appreciated that, if desired and appropriate, some or all of the software can be embodied as part of a device's operating system.

With reference to FIGS. 2-6, in one embodiment the sensor 42 is an optical sensor and transmits light (e.g., flashes a high intensity light emitting diode (LED)) within the service brake volume 26 in a step 110. The light is directed toward the pattern 46 on the service volume diaphragm 32, which is mounted on the plate 33. The light illuminates and is reflected from the service volume diaphragm 32 and received back at the sensor 42 as an image (e.g., an optical image) in a step 112. Based on the image received by the sensor 42 after being reflected from the service volume diaphragm 32, the sensor electronics 52 determine a position of the service volume diaphragm 32 (and the plate 33) in the housing 24 by determining a distance of the service volume diaphragm 32 (and the plate 33) from the sensor 42 based on the image. In the illustrated embodiment where the sensor 42 is positioned proximate to the wall 44 of the brake chamber housing 24, the distance determined by the sensor electronics 52 is also representative of the distance of the service volume diaphragm 32 (and the plate 33) from the wall 44. A position of the service volume diaphragm 32 (and the plate 33) within the service brake volume 26 is determined in a step 114 by the sensor electronics 52 based on the distance of the service volume diaphragm 32 (and the plate 33) from at least one of the sensor 42 and the wall 44 of the brake chamber housing 24.

In the illustrated embodiment, the image received at the sensor 42 in the step 112 includes position information e.g., the marks 50 of the pattern 46) and indicates a position of the service volume diaphragm 32 (and the plate 33) in the housing 24. As illustrated in FIGS. 4 and 5, the number of the marks 50 within a field of view 60 of the sensor 42 changes based on the distance between the sensor 42 and the pattern 46 on the service volume diaphragm 32 (and the plate 33). For example, when the service volume diaphragm 32 (and the plate 33) are farther away from the wall 44 of the brake chamber housing 24 (see FIG. 2), the field of view 60 of the sensor 42 is larger (see FIG. 4). Conversely, when the service volume diaphragm 32 (and the plate 33) are closer to the wall 44 of the brake chamber housing 24 (see FIG. 3), the field of view 60 of the sensor 42 is smaller (see FIG. 5). When the field of view 60 of the sensor 42 is larger (see FIG. 4), the sensor 42 senses (e.g., “sees”) relatively more marks 50 in the pattern 46 than when the field of view ($0 of the sensor 42 is smaller (see FIG. 5). For example, the sensor 42 senses seven (7) of the marks 50 in the pattern 46 in FIG. 4, and the sensor 42 only senses four (4) of the marks 50 in the pattern 46 in FIG. 5. The sensor electronics 52 determine the position of the service volume diaphragm 32 (and the plate 33) by identifying the pattern 46, which is used for determining the distance between the sensor 42 and the service volume diaphragm 32 (and the plate 33). In that regard, the sensor electronics 52 determine the position of the service volume diaphragm 32 (and the plate 33) based on the image of the pattern 46.

It is contemplated that the light may be visible light or infrared light. It is also contemplated that instead of transmitting and receiving light the signal sensor 42 may transmit and receive an ultrasound signal. In this case, the sensor 42 may determine the distance between the sensor 42 and the service volume diaphragm 32 (and the plate 33) based on a time delay between when the sound signal is transmitted in the step 110 and when the reflected signal is received back at the sensor 42 in the step 112. The position of the service volume diaphragm 32 (and the plate 33) within the service brake volume 26 is then determined in the step 114 by the sensor electronics 52 based on the distance of the service volume diaphragm 32 (and the plate 33) from at least one of the sensor 42 and the wall 44 of the brake chamber housing 24.

In one embodiment, the sensor electronics 52 receives a message from the ECU 22 indicating a level of service brake demand in a step 116. For example, if the operator of the vehicle is not currently depressing the service brake pedal 14, the message from the ECU 22 to the sensor electronics 52 indicates no service braking is demanded. If the operator of the vehicle is currently depressing the service brake pedal 14 about one-half of a maximum distance, the message from the ECU 22 to the sensor electronics 52 indicates about one-half of a maximum service braking, is demanded. The operator of the vehicle is currently depressing the service brake pedal 14 about the maximum distance, the message from the ECU 22 to the sensor electronics 52 indicates about the maximum service braking is demanded. The ECU 22 can infer brake imbalance from more than one sensor 42. The optical sensor alone can infer contamination in the brake chamber if the image is blurry. The sensor 42 can also infer brake chamber pressure with a known volume.

In this embodiment, the sensor electronics 52 are calibrated to identify expected positions (e.g., baseline positions) of the respective service volume diaphragms 32 (arid plates 33) based on the level of service brake demand (e.g., based on a position of the service brake pedal 14). The sensor electronics 52 compare the position of the service volume diaphragm 32 (and plate 33) within the respective service brake volume 26 with the expected position in a step 120, if the position of any of the service volume diaphragms 32 (and plates 33) is not within a predetermined tolerance of the expected position (e.g., if any of the service volume diaphragms 32 (and plates 33) remain, or “stick”, in the Brake ON position for applying the associated service brake even after the service brake pedal 14 is released), the respective sensor electronics 52 transmit a message to the ECU 22 for alerting the vehicle operator in a step 122. For example, the ECU 22 may alert the driver by illuminating a dashboard light and/or sounding a buzzer in the operator cab. Therefore, in this embodiment, the sensor electronics 52 determine the position of the service volume diaphragm 32 (and plate 33) within the respective service brake volume 26.

In another embodiment, the sensor electronics 52 transmit a message to the ECU 22 indicating the position of the service volume diaphragm 32 (and plate 33) within the service brake volume 21 in a step 130. It is contemplated that the ECU 22 may receive messages from a plurality of respective ones of the sensor electronics 52 in a step 132. Upon receiving the respective messages from the sensor electronics 52, the ECU 22 identities the positions of the service volume diaphragms 32 (and plates 33) within the respective service brake volumes 26 in a step 134.

The ECU 22 may compare the positions of the service volume diaphragm 32 (and plate 33) with the expected positions (e.g., baseline positions) of the respective service volume diaphragms 32 (and plates 33) based on the level of service brake demand in a step 136. If the ECU 22 determines that the position of any of the service volume diaphragms 32 (and plates 33) is not within a predetermined tolerance of the expected position, the. ECU 22 transmits a message to the vehicle communication bus 56 for alerting the vehicle operator in a step 140.

Alternatively, the ECU 22 may compare the positions of the respective service volume diaphragms 32 (and plates 33) with the positions of the other service volume diaphragms 32 (and plates 33) in a step 142. For example, if the ECU 22 determines that the position of any of the service volume diaphragms 32 (and plates 33) is not within a predetermined tolerance of an average position of all of the service volume diaphragms 32 (and plates 33) and/or a tolerance of the positions of one or more of the other service volume diaphragms 32 (and plates 33) the ECU 22 transmits a message to the vehicle communication bus 56 for alerting the vehicle operator in the step 140.

Although the illustrated embodiment includes the sensor 42 in the housing wall 44 on ton-pressure side 40 of the service brake volume 26, it is contemplated that the sensor 42 may instead be on the pressure side 36 of the service brake volume 26. In that case, the pattern 46 may be on the diaphragm 32.

If the sensor 42 transmits sound signals, those signals would then be reflected off of the housing wall 44. Other embodiments in which the sensor 42 is on the pressure side 36 of the service brake volume 26 are also contemplated.

With reference again to FIGS. 1-3, it is contemplated that the ECU 22 receives the messages (message signals) from the sensor electronics 52 via an ECU receiver 62. In the embodiments described above, the ECU receiver 62 is an electrical input port of the ECU 22 that receives the messages from the sensor electronics 52 via the vehicle communication bus 56. Alternatively, in another embodiment, it is also contemplated that the ECU receiver 62 is an antenna for wirelessly communicating with the sensor electronics 52, which in this embodiment would also include an antenna for wireless communication.

It is also understood that the ECU 22 includes a processor 64 that acts as a means for evaluating the message signals from the sensor electronics 52, which may include interpreting the messages front the sensor electronics 52, comparing the positions of the service volume diaphragms 32 (and plates 33) with, for example, the respective baseline positions or the average of the positions, determining the statuses of the respective service brake volumes 26 based on the evaluations of the signals front the sensor electronics 52 (e.g., based on the comparisons), and transmitting any messages for alerting the operator of the vehicle 10. Therefore, the ECU 22 and/or the ECU processor 64 act as as means for evaluating the signals. The ECU 22 and/or the ECU processor 64 may also act as a means for determining respective positions of diaphragms in service air brake volumes of the brake chambers and for determining the respective statuses of the service brake chambers 26 based on the evaluations of the signals.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A brake chamber, comprising:
a housing defining a service air brake volume;
a diaphragm associated with a plate that is movably secured within the housing, the diaphragm dividing the service air brake volume into a pressure portion and a non-pressure portion, respective volumes of the pressure portion and the non-pressure portion changing as the diaphragm moves within the housing;
an optical sensor immovably positioned in the service air brake volume proximate a wall of the housing and across from the diaphragm; and
electronics, associated with the optical sensor, determining a position of the plate in the housing based on an image reflected off of the diaphragm and received by the optical sensor.

2. (canceled)

3. The brake chamber as set forth in claim 1, wherein:
the sensor transmits light toward the plate;
the image is a reflection of the light off of the diaphragm.

4. The brake chamber as set forth in claim 3, wherein:
the light is one of visible light and infrared light.

5. The brake chamber as set forth in claim 1, further including:
a pattern, positioned in the housing, within a sensing range of the sensor;
wherein the image received by the sensor is an optical image of the pattern; and
wherein the electronics determine the position of the plate based on the image of the pattern.

6. The brake chamber as set forth in claim 5, wherein:
the pattern includes a plurality of marks;
a number of the marks in a field of view of the sensor changes based on the position of the diaphragm; and
the electronics determine the position of the plate based on the number of the marks in the field of view of the sensor.

7. The brake chamber as set forth in claim 1, wherein:
the electronics also determine the position of the plate based on an ultrasound signal,

8. The brake chamber as set forth in claim 7, wherein:
the ultrasound signal is reflected from at least one of the diaphragm and a wall of the housing; and
the electronics determine the position of the plate based on the reflected ultrasound signal.

9. An electronic control unit in a vehicle brake system, the electronic control unit composing:
a receiver receiving respective messages from a plurality of optical sensors associated with respective brake chambers, the optical sensors being immovably positioned in a service air brake volume proximate a wall of a housing and across from a diaphragm and receiving reflected images indicating a status of the brake chambers;
means for evaluating the optical messages; and
means for determining respective statuses of the brake chambers based on the evaluations of the optical messages.

10. The electronic control unit in a vehicle brake system as set forth in claim 9, wherein the receiver includes:
an input port receiving the respective messages from the plurality of sensors via a vehicle communication bus.

11. The electronic control unit in a vehicle brake system as set forth in claim 9, wherein the receiver includes:
an antenna for wirelessly receiving the respective messages from the plurality of sensors.

12. The electronic control unit in a vehicle brake system as set forth in claim 9, wherein means for determining respective statuses of the brake chambers includes:
means for determining respective positions of plates in service air brake volumes of the brake chambers.

13. The electronic control unit in a vehicle brake system as set forth in claim 12, the electronic control unit further including:
means for comparing the positions of the plates with respective baseline positions; and
means for identifying any of the brake chambers including the plate outside of a tolerance of the respective baseline position.

14. The electronic control unit in a vehicle brake system as set forth in claim 13, wherein the means for comparing includes:
means for comparing the positions of the plates with respective baseline positions based on a position of a service braked pedal.

15. The electronic control unit in a vehicle brake system as set forth in claim 12, the electronic control unit further including:
means for comparing the positions of the plates with the positions of the other plates; and
means for identifying any of the brake chambers including a respective one of the plates outside of a position range determined based on the positions of the plates.

16. The electronic control unit in a vehicle brake system as set forth in claim 13, wherein the electronic control unit further includes:
means for notifying a driver of the vehicle if any of the plates is outside of the respective tolerance.

17. A braking system for a heavy vehicle, the braking system comprising:
a plurality of brake chambers, each of the brake chambers including:
a housing defining a service air brake volume;
a diaphragm associated with a plate that is movably secured within the housing dividing the service air brake volume into a pressure portion and a non-pressure portion, respective volumes of the pressure portion and the non-pressure portion changing, as the plate moves within the housing;
an optical sensor immovably positioned in the service air brake volume proximate a wall of the housing and across from the diaphragm; and
electronics, associated with the optical sensor, determining a position of the plate in the housing based on an image reflected off of the diaphragm and received by the optical sensor, and transmitting a message signal based on the position of the plate in the housing; and
and electronic control unit, comprising:
a receiver receiving the respective message signals from the plurality of sensors;
means for evaluating the message signals; and
means for determining respective statuses of the brake chambers based on the evaluations of the message signals.

18. (canceled)

19. The braking system for a heavy vehicle as set forth in claim 17, wherein:
the receiver receives the respective message signals from at least one of the brake chamber electronics;
the means for evaluating the message signals compares the positions identified in the respective message signals received by the receiver; and
the means for determining, determines the respective statuses of the brake chambers based on the comparisons of the positions identified in the respective message signals.

20. The braking system for a heavy vehicle as set forth in claim 19, wherein:
the means for evaluating the message signals compares the positions identified in the message signals received by the receiver with respective baseline positions; and
the means for determining determines the respective statuses of the brake chambers based on the comparisons of the positions identified in the respective message signals with the respective baselines.

21. The braking system for a heavy vehicle as set forth in claim 19, wherein:
the means for evaluating the message signals compares the positions identified in the message signals received by the receiver with the positions identified in the other message signals; and
the means for determining determines the respective statuses of the brake chambers based on the comparisons of the positions identified in the respective message signals with the positions identified in the other message signals.

22. The braking system for a heavy vehicle as set forth in claim 19, wherein:
the means for evaluating compares the positions identified in the respective message signals received by the receiver with respective baseline positions based on a service brake demand.

23. A method for determining a position of a plate in a housing defining a service air brake volume, the method including:
receiving a reflected optical image in a sensor immovably positioned in the service air brake volume proximate a wall of the housing and across from a service air brake volume diaphragm, the optical image indicating a position of the plate in the housing; and
determining the position of the plate in the housing based on the reflected optical image received by the sensor.

24. (canceled)

25. The method for determining a position of a plate in a housing as set forth in claim 23, further including:
identifying a pattern in the housing based on the image received in the sensor; and
determining the position of the plate in the housing based on the identified pattern.

26. A method for determining a status of a brake chamber, the method comprising:
receiving a reflected optical indication in a sensor immovably positioned in a service brake chamber proximate a wall of a housing and across from a service brake chamber diaphragm, the optical indication indicating a position of a plate in the service brake chamber; and
determining the status of the brake chamber based on the optical indication of the plate.

27. The method for determining a status of a brake chamber as set forth in claim 26, wherein receiving step includes:
receiving a message from an optical sensor in the service brake chamber via one of a vehicle communication bus and a direct connection.

28. The method for determining a status of a brake chamber as set forth in claim 26, wherein the determining step includes:
comparing the position of the plate with a baseline position.

29. The method for determining a status of a brake chamber as set forth in claim 26, further including:
receiving a second indication of a position of a second plate in a second brake chamber, and
determining the status of the brake chamber and the second brake chamber based on the positions of the plate and the second plate, respectively.

30. The method for determining a status of a brake chamber as set forth in claim 29, wherein the determining step includes:
comparing the position of the plate with the position of the second plate;
determining the status of the brake chamber based on the comparison of the positions of the plate and the second plate; and
determining the status of the second brake chamber based on the comparison of the positions of the plate and the second plate.

31. A brake chamber, comprising:
a housing defining a service air brake volume,
a diaphragm associated with a plate that is movably secured within the housing dividing the service air brake volume into a pressure portion and a non-pressure portion, respective volumes of the pressure portion and the non-pressure portion changing as the diaphragm and plate move within the housing; and
an optical means, determining a position of the plate in the housing, immovably positioned in the service air brake volume proximate a wall of the housing and across from the diaphragm.

32. The brake chamber as set forth in claim 31, wherein the optical means for determining the position of the plate in the housing includes:
an optical sensor immovably positioned in the service air brake volume proximate the wall of the housing and across from the diaphragm; and
electronics, associated with the optical sensor, determining a position of the diaphragm in the housing based on an image taken inside the housing, the image being reflected off of the diaphragm and received by the optical sensor.
